(19) United States
(12) Patent Application Publication
(10) Pub. No.: US 2011/0026889 A1
(43) Pub. Date: Feb. 3, 2011

(54) Tight-Buffered Optical Fiber Unit Having Improved Accessibility

(75) Inventors: Brian G. Risch, Granite Falls, NC (US); Timo Tapio Perttunen, Brondby (DK)

Correspondence Address: SUMMA, ADDITON & ASHE, P.A., 11610 NORTH COMMUNITY HOUSE ROAD, SUITE 200, CHARLOTTE, NC, 28277, US

(73) Assignee: DRAKA COMTEQ B.V., Amsterdam (NL)

(21) Appl. No.: 12/843,116

(22) Filed: Jul. 26, 2010

Related U.S. Application Data
(60) Provisional application No. 61/230,158, filed on Jul. 31, 2009.

(51) Int. Cl. G02B 6/44; B29D 11/00

(52) U.S. Cl. 385/102; 264/1.29

(57) ABSTRACT

Disclosed are tight-buffered and semi-tight-buffered optical fiber units. The optical fiber unit includes an optical fiber that is surrounded by a polymeric buffering layer to define a fiber-buffer interface. The buffering layer includes an aliphatic amide slip agent in an amount sufficient for at least some of the aliphatic amide slip agent to migrate to the buffer-fiber interface to thereby promote easy stripping of the buffering layer. For example, at least about 15 centimeters of the polymeric buffering layer can be removed from the optical fiber in a single operation using a strip force of less than about 10 N.

### CROSS-REFERENCE TO PRIORITY APPLICATION

This application claims the benefit of commonly assigned U.S. Patent Application No. 61/230,158, for a Tight-Buffered Optical Fiber Unit Having Improved Accessibility (filed Jul. 31, 2009), which is hereby incorporated by reference in its entirety.

### FIELD OF THE INVENTION

The present invention relates to tight or semi-tight buffering units having improved accessibility.

### BACKGROUND

Within fiber optic networks, tight and semi-tight buffered optical fibers are commonly employed in various applications where space is limited. For example, tight and semi-tight buffered optical fibers are often used in pigtails (i.e., short patch cables) and passive devices (e.g., optical fiber splitters, couplers, and attenuators) where additional protection is desired for individual optical fibers.

One problem encountered when using tightly buffered optical fibers is that of accessibility. It is desirable to be able to remove the protective buffer tube quickly, so that the enclosed optical fiber can be readily accessed.

A conventional solution for providing improved accessibility is to provide a gap between the buffer tube and the enclosed optical fiber.

This gap is often filled with a lubricant to reduce friction between the optical fiber and the surrounding buffer tube. Using a lubricant layer, however, can be difficult from a manufacturing standpoint, because a lubricant layer requires additional tooling and high precision.

If an air-filled gap is employed, the buffer tube may be susceptible to the ingress of water. Those of ordinary skill will appreciate that water infiltrating the buffer tube, for example, may freeze, which, inter alia, can contribute to optical fiber attenuation. Moreover, the air-filled gap provides space that can allow the enclosed optical fiber to buckle or otherwise bend, which in turn can lead to undesirable attenuation.

Accordingly, it would be desirable to have a more tightly buffered optical fiber having improved accessibility and not requiring a substantial gap between the buffer tube and the enclosed optical fiber.

### SUMMARY

The present invention relates to tight-buffered and semi-tight-buffered optical fiber units having respective geometries that facilitate exceptional accessibility (e.g., stripping performance), while maintaining low attenuation.

In one aspect, the present invention embraces a tight-buffered optical fiber unit. The tight-buffered optical fiber unit includes an optical fiber (i.e., a glass fiber surrounded by one or more coating layers). A polymeric buffering layer tightly surrounds the optical fiber to define a fiber-buffer interface. The buffering layer includes a slip agent (e.g., an aliphatic amide) in an amount sufficient for at least some of the slip agent to migrate to the buffer-fiber interface. The slip agent promotes easy stripping of the buffering layer, despite the tight geometry of the tight-buffered optical fiber unit. In this regard, at least about 15 centimeters of the polymeric buffering layer can be removed (e.g., stripped) from the optical fiber in a single operation using a strip force of less than about 10 N (e.g., about 4 N or less).

In another aspect, the present invention embraces a semi-tight-buffered optical fiber unit. The semi-tight buffered optical fiber unit includes an optical fiber (i.e., a glass fiber surrounded by one or more coating layers). A polymeric buffering layer surrounds the optical fiber to define an annular gap therebetween. As compared with conventional semi-tight structures, the present semi-tight-buffered optical fiber unit can employ a significantly narrower gap between the optical fiber and the surrounding buffering layer, while maintaining good accessibility. The buffering layer includes a slip agent (e.g., an aliphatic amide) in an amount sufficient for at least some of the slip agent to migrate to the buffer-fiber interface (e.g., the narrow gap between the buffering layer and the optical fiber). The slip agent promotes easy stripping of the buffering layer, despite the semi-tight-buffered optical fiber unit having a significantly narrower gap than conventional semi-tight structures. Here, too, at least about 15 centimeters (e.g., at least about 35 centimeters, such as at least about 75 centimeters) of the polymeric buffering layer can be removed from the optical fiber in a single operation using a strip force of less than about 10 N (e.g., about 5 N or less).

In either aspect, the buffered optical fiber can be either a multimode optical fiber (MMF) or a single-mode optical fiber (SMF).

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts an exemplary tight-buffered optical fiber unit according to the present invention.

FIG. 2 schematically depicts an exemplary semi-tight-buffered optical fiber unit according to the present invention.

### DETAILED DESCRIPTION

The present invention provides buffer tube structures that provide enhanced accessibility to a buffered optical fiber (e.g., an optical fiber tightly or semi-tightly surrounded by a polymeric buffering layer). In particular, the buffering layer (i.e., buffer tube) is doped with a sufficient concentration of slip agent to provide a reduced-friction interface between the buffer tube and its enclosed optical fiber.

Exemplary slip agents include aliphatic amides, particularly amides of unsaturated fatty acids (e.g., oleic acid). Exemplary aliphatic amide slip agents include oleamide (C₁₈H₃₅NO) and erucamide (C₂₂H₄₃NO). A suitable oleamide-based slip agent is 075840JUMB Slipeze, which is commercially available from PolyOne Corporation.

The buffer tube is doped with the slip agent in an amount sufficient for at least some of the slip agent to migrate (i.e., bloom) to the inner surface of the buffer tube. Typically, the slip agent is incorporated into the buffer tube in a concentration less than about 5000 parts per million (ppm) (e.g., less than about 3000 ppm, such as less than about 1500 ppm). More typically, the slip agent is incorporated in the buffer tube in a concentration between about 200 ppm and 2000 ppm (e.g., between about 500 ppm and 1250 ppm).

Furthermore, the slip agent may possess low solubility within the buffering material (i.e., the material used to form the buffer tube) to facilitate blooming of the slip agent at the inner surface of the buffer tube.

The slip agent promotes easy access to an optical fiber contained within the buffer tube. In other words, the slip agent makes it easier to strip the buffer tube from the optical fiber.

The slip agent may be incorporated into the buffer tube through a masterbatch process.

First, an intermediate masterbatch is created by mixing a carrier material (e.g., a polyolefin) with a slip agent. Exemplary carrier materials include low-density polyethylene (LDPE), linear low-density polyethylene (LLDPE), high-density polyethylene (HDPE), and polypropylene (PP). The resulting masterbatch has a slip agent concentration of between about 1 percent and 10 percent (e.g., about 5 percent or so).

After the masterbatch is created, it is mixed with a polymeric composition to form a buffering compound. Other additives, such as colorants, may be added to the masterbatch and/or mixed with the polymeric composition.

The masterbatch is typically included within the buffering compound at a concentration of between about 1 percent and 5 percent (e.g., between about 3 percent and 3.5 percent), resulting in a slip agent concentration of between about 0.01 percent and 0.5 percent in the buffering compound (i.e., between about 100 ppm and 5000 ppm). An exemplary slip agent concentration in the buffering compound might fall between about 750 ppm and 2000 ppm (e.g., 1000 ppm to 1500 ppm).

The buffering compound is then extruded (e.g., continuously extruded) about an optical fiber. For example, an optical fiber is advanced through an extruder crosshead, which forms an initially molten polymeric buffer tube around the optical fiber. The molten polymeric buffer tube subsequently cools to form a final product.

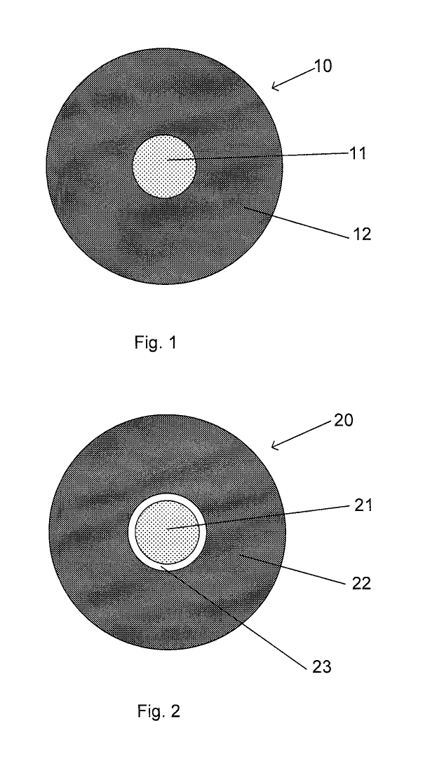

In one aspect schematically depicted in FIG. 1, the present invention embraces a tight buffering unit 10 (i.e., a tight-buffered optical fiber) having improved accessibility.

The tight buffering unit 10 includes an optical fiber 11 surrounded by a buffering layer 12 (i.e., a buffer tube). The buffer tube 12 is formed from a polymeric composition that has been enhanced through the incorporation of a slip agent, which typically possesses low solubility with the polymeric composition to facilitate the migration of the slip agent (e.g., an aliphatic amide slip agent) to the fiber-buffer interface. During and after buffer-tube extrusion, at least some of the slip agent migrates to the inner surface of the buffer tube 12. As a result, the interface between the buffer tube 12 and the optical fiber 11 is lubricated. This reduces friction between the optical fiber 11 and the tight buffer tube 12, providing improved accessibility to the optical fiber 11.

The optical fiber 11 is tightly (i.e., closely) surrounded by the buffer tube 12. That is, the outer diameter of the optical fiber 11 is approximately equal to the inner diameter of the buffer tube 12. Consequently, there is substantially no space (e.g., annular space) between the outer surface of the optical fiber 11 and the inner surface of the buffer tube 12.

In this regard, the buffer tube usually has an inner diameter of between about 0.235 millimeter and 0.265 millimeter. Those of ordinary skill will recognize that an optical fiber (e.g., a single-mode optical fiber (SMF) or a multi-mode optical fiber (MMF)) with a primary coating (and an optional secondary coating and/or ink layer) typically has an outer diameter of between about 235 microns (μm) and 265 microns.

Alternatively, the present tight buffering unit may include an optical fiber possessing a reduced diameter (e.g., an outermost diameter between about 150 microns and 230 microns). As such, the buffer tube may have an inner diameter of between about 0.15 millimeter and 0.23 millimeter.

The buffer tube typically possesses an outer diameter of between about 0.4 millimeter and 1 millimeter (e.g., between about 0.5 millimeter and 0.9 millimeter).

The buffer tube may be formed predominately of polyolefins, such as polyethylene (e.g., LDPE, LLDPE, or HDPE) or polypropylene, including fluorinated polyolefins, polyesters (e.g., polybutylene terephthalate), polyamides (e.g., nylon), ethylene-vinyl acetate (EVA), as well as other polymeric materials and blends. The polymeric materials may include a curable composition (e.g., a UV-curable material) or a thermoplastic material.

In this regard, the buffer tube typically has a Shore D hardness of at least about 45 and a Shore A hardness of at least about 90 (e.g., a Shore A hardness of greater than about 95). More typically, the buffer tube has a Shore D hardness of at least about 50 (e.g., a Shore D hardness of about 55 or more).

An exemplary polymeric composition for use in forming the buffering compound is ECCOH™ 6638, a halogen-free flame-retardant (HFFR) compound that includes polyethylene, EVA, halogen-free flame retardants, and other additives. A buffer tube formed from ECCOH™ 6638 typically has a Shore D hardness of about 53. Another exemplary polymeric composition is ECCOH™ 6150, which is also an HFFR compound. ECCOH™ 6638 and ECCOH™ 6150 are commercially available from PolyOne Corporation.

Other exemplary compositions include MEGOLON™ HF 1876 and MEGOLON™ HF 8142, which are HFFR compounds that are commercially available from Alpha Gary Corporation. A buffer tube formed from MEGOLON™ HF 1876 typically has a Shore A hardness of about 96 and a Shore D hardness of about 58.

In general, the buffer tube may be formed of one or more layers. The layers may be homogeneous or include mixtures or blends of various materials within each layer. For example, the buffer materials may contain additives, such as nucleating agents, flame-retardants, smoke-retardants, antioxidants, UV absorbers, and/or plasticizers. The buffer tube may include a material to provide high temperature resistance and chemical resistance (e.g., an aromatic material or polysulfone material).

The buffer tubes according to the present invention typically possess a circular cross section. That said, it is within the scope of the present invention to employ buffer tubes possessing non-circular shapes (e.g., an oval or a trapezoidal cross-section) or even somewhat irregular shapes.

In another embodiment schematically depicted in FIG. 2, the present invention embraces a semi-tight buffering unit 20 with improved accessibility. The semi-tight buffering unit 20 is similar to the tight buffering unit described above; however, it further includes a buffering gap 23 (e.g., an air gap) between the optical fiber 21 and the buffer tube 22.

Typically, the buffering gap is an air gap and, as such, is substantially free of materials other than slip agent that has migrated to the buffering gap.

The buffering gap (e.g., an annular gap) may have a thickness less than about 50 microns (e.g., about 25 microns). Typically, the buffering gap has a thickness of no more than about 30 microns. In other words, the inner diameter of the buffer tube is typically no more than about 60 microns greater than the outer diameter of the optical fiber it encloses. For example, a buffer tube having an inner diameter of about 0.3 millimeter may enclose an optical fiber having an outer diameter of about 240 microns, resulting in a buffering gap having a thickness of about 30 microns.

As compared with conventional semi-tight structures, the present semi-tight-buffered optical fiber unit may possess a narrower buffering gap between the optical fiber and the buffer tube, yet provide excellent accessibility. For example, the buffering gap may have a thickness of less than about 15 microns (e.g., less than about 10 microns). By way of further example, the buffering gap may have a thickness of less than about 5 microns.

The buffering units according to the present invention may contain either a multimode optical fiber or a single-mode optical fiber.

In one embodiment, the present buffering units employ conventional multimode optical fibers having a 50-micron core (e.g., OM2 multimode fibers) and complying with the ITU-T G.651.1 recommendation. The ITU-T G.651.1 recommendation is hereby incorporated by reference in its entirety. Exemplary multimode fibers that may be employed include MaxCap™ multimode fibers (OM2+, OM3, or OM4), which are commercially available from Draka (Claremont, N.C.).

Alternatively, the present data-center cable 10 may include bend-insensitive multimode fibers, such as MaxCap™-BB-OMx multimode fibers, which are commercially available from Draka (Claremont, N.C.). In this regard, bend-insensitive multimode fibers typically have macrobending losses of (i) no more than 0.1 dB at a wavelength of 850 nanometers for a winding of two turns around a spool with a bending radius of 15 millimeters and (ii) no more than 0.3 dB at a wavelength of 1300 nanometers for a winding of two turns around a spool with a bending radius of 15 millimeters.

In contrast, conventional multimode fibers, in accordance with the ITU-T G.651.1 standard, have macrobending losses of (i) no more than 1 dB at a wavelength of 850 nanometers for a winding of two turns around a spool with a bending radius of 15 millimeters and (ii) no more than 1 dB at a wavelength of 1300 nanometers for a winding of two turns around a spool with a bending radius of 15 millimeters. Moreover, as measured using a winding of two turns around a spool with a bending radius of 15 millimeters, conventional multimode fibers typically have macrobending losses of (i) greater than 0.1 dB, more typically greater than 0.2 dB (e.g., 0.3 dB or more), at a wavelength of 850 nanometers and (ii) greater than 0.3 dB, more typically greater than 0.4 dB (e.g., 0.5 dB or more), at a wavelength of 1300 nanometers.

In another embodiment, the optical fibers employed in the present buffering units are conventional standard single-mode fibers (SSMF). Suitable single-mode optical fibers (e.g., enhanced single-mode fibers (ESMF)) that are compliant with the ITU-T G.652.D requirements are commercially available, for instance, from Draka (Claremont, N.C.).

In another embodiment, bend-insensitive single-mode fibers may be employed in the buffering units according to the present invention. Bend-insensitive optical fibers are less susceptible to attenuation (e.g., caused by microbending or macrobending). Exemplary single-mode glass fibers for use in the present buffer tubes are commercially available from Draka (Claremont, N.C.) under the trade name BendBright®, which is compliant with the ITU-T G.652.D recommendation. That said, it is within the scope of the present invention to employ a bend-insensitive glass fiber that meets the ITU-T G.657.A standard and/or the ITU-T G.657.B standard. The ITU-T G.652.D and ITU-T G.657.A/B recommendations are hereby incorporated by reference in their entirety.

In this regard, exemplary bend-insensitive single-mode glass fibers for use in the present invention are commercially available from Draka (Claremont, N.C.) under the trade name BendBright^{XS}®, which is compliant with both the ITU-T G.652.D and ITU-T G.657.A/B recommendations. BendBright^{XS}® optical fibers demonstrate significant improvement with respect to both macrobending and microbending.

As set forth in commonly assigned International Patent Application No. PCT/U.S.08/82927 for a Microbend-Resistant Optical Fiber, filed Nov. 9, 2008, (Overton) (and its counterpart International Patent Application Publication No. WO 2009/062131 A1), and U.S. patent application Ser. No. 12/267,732 for a Microbend-Resistant Optical Fiber, filed Nov. 10, 2008, (Overton) (and its counterpart U.S. Patent Application Publication No. US2009/0175583 A1), pairing a bend-insensitive glass fiber (e.g., Draka's single-mode glass fibers available under the trade name BendBright^{XS}®) and a primary coating having very low modulus achieves optical fibers having exceptionally low losses (e.g., reductions in microbend sensitivity of at least 10× as compared with a single-mode fiber employing a conventional coating system). The optical fiber units according to the present invention may employ the coatings disclosed in International Patent Application No. PCT/U.S.08/82927 and U.S. patent application Ser. No. 12/267,732 with either single-mode optical fibers or multimode optical fibers.

The optical fibers employed with the present buffering units may also comply with the IEC 60793 and IEC 60794 standards, which are hereby incorporated by reference in their entirety.

As previously noted, optical fibers typically have an outer diameter of between about 235 microns and 265 microns, although optical fibers having a smaller diameter are within the scope of the present invention.

By way of example, the component glass fiber may have an outer diameter of about 125 microns. With respect to the optical fiber's surrounding coating layers, the primary coating may have an outer diameter of between about 175 microns and 195 microns (i.e., a primary coating thickness of between about 25 microns and 35 microns), and the secondary coating may have an outer diameter of between about 235 microns and 265 microns (i.e., a secondary coating thickness of between about 20 microns and 45 microns). Optionally, the optical fiber may include an outermost ink layer, which is typically between two and ten microns.

The buffering units according to the present invention have superior attenuation performance compared to conventional buffering units having similar accessibility. For example, tight buffering units according to the present invention have similar accessibility to conventional semi-tight buffering units, but have superior attenuation performance.

Accessibility is tested by determining the length of the buffer tube that can be removed in a single operation, thereby allowing access to the optical fiber inside. Accessibility testing is typically performed about 24 hours after the buffer tube has been extruded to ensure that at least a portion of the slip agent has bloomed from the buffer tube.

In this regard, typically at least about 15 centimeters (e.g., at least about 25 centimeters) of the buffer tube of a tight or semi-tight buffering unit in accordance with the present invention can be removed in a single operation (i.e., in one piece) using a strip force of less than about 10 N, such as less than about 8 N (e.g., less than about 5 N). In a particular embodiment, at least about 50 centimeters (e.g., one meter or more) of the buffer tube of a semi-tight buffering unit can be removed in a single operation using a strip force of less than about 10 N, such as less than about 8 N (e.g., no more than about 6 N). In another particular embodiment, at least about 20 centimeters (e.g., greater than 30 centimeters) of the buffer tube of a tight buffering unit can be removed in a single operation using a strip force of less than about 10 N, such as less than about 6 N (e.g., about 4 N).

Accordingly, the optical fiber inside the present buffering units can be quickly accessed. For example, the present buffering units are capable of having about one meter of buffer tube removed in no more than one minute, typically in one or two pieces.

As noted, the buffering units according to the present invention have superior attenuation performance. In this regard, the attenuation of buffering units can be measured using temperature cycle testing. For example, a sample of a buffering unit may be temperature cycled from −5° C. to 60° C. This temperature cycling is typically performed twice on the sample (i.e., two cycles from −5° C. to 60° C.).

Alternatively, more rigorous temperature cycling may be performed (e.g., two cycles from −20° C. to 60° C. or two cycles from −40° C. to 60° C.). In addition, further temperature cycling (e.g., two cycles from −40° C. to 70° C.) after the initial temperature cycling may be performed.

After temperature cycling, the attenuation of the optical fiber contained within the tight buffering unit is typically measured at −5° C. For a multimode fiber, attenuation is often measured at a wavelength of 1300 nanometers. Multimode-fiber tight buffering units (e.g., containing a conventional multimode fiber) according to the present invention typically have attenuation less than about 1 dB/km, more typically less than about 0.8 dB/km (e.g., about 0.6 dB/km or less), measured at −5° C. after performing two temperature cycles from −5° C. to 60° C. Furthermore, multimode-fiber tight buffering units in accordance with the present invention typically have attenuation of no more than about 2.7 dB/km at a wavelength of 850 nanometers and no more than about 0.8 dB/km at a wavelength of 1300 nanometers, measured at −5° C. after performing two temperature cycles from −40° C. to 70° C.

The attenuation of tight buffering units containing single-mode optical fibers (e.g., conventional single-mode optical fibers) is typically no more than about 0.5 dB/km (e.g., less than about 0.39 dB/km) at a wavelength of 1310 nanometers and no more than about 0.30 dB/km (e.g., 0.25 dB/km or less) at a wavelength of 1550 nanometers, measured at −5° C. after performing two temperature cycles from −40° C. to 70° C.

Table 1 (below) depicts representative attenuation data from exemplary tight buffering units. These exemplary buffering units contain a conventional multimode fiber having a 50-micron core and an outer diameter of about 240 microns. Examples 4 and 5 are comparative, conventional semi-tight buffering units.

TABLE 1
(Conventional MMF Attenuation in Tight Buffering Units)

| | Ex. 1 | Ex. 2 | Ex. 3 | Comp. Ex. 4 | Comp. Ex. 5 |
|---|---|---|---|---|---|
| Buffer Tube | 0.9 | 0.9 | 0.9 | 0.9 | 0.9 |
| Outer Diameter (mm) | | | | | |
| Buffer Tube | 0.24 | 0.24 | 0.24 | 0.30 | 0.30 |
| Inner Diameter (mm) | | | | | |
| Buffering gap | N/A | N/A | N/A | Air | Lubricant |
| Buffering Material | ECCOH ™ 6638 | ECCOH ™ 6638 | ECCOH ™ 6638 | ECCOH ™ 6638 | ECCOH ™ 6638 |
| Slip Agent | 075840JUMB | 075840JUMB | 075840JUMB | N/A | N/A |
| | Slipeze | Slipeze | Slipeze | | |
| Slip Agent | 500 | 1000 | 2000 | N/A | N/A |
| Concentration (ppm) | | | | | |
| Attenuation | | 0.53 | | 0.98 | 1.77 |
| (dB/km at 1300 nm) | | | | | |
| Two cycles −5° C. | | | | | |
| to 60° C. | | | | | |
| Attenuation | | 0.75 | | 2.12 | 11.44 |
| (dB/km at 1300 nm) | | | | | |
| Two cycles −40° C. | | | | | |
| to 60° C. | | | | | |
| Attenuation | 0.92 | 0.98 | 0.91 | 10.97 | |
| (dB/km at 1300 nm) | | | | | |
| Two cycles −20° C. | | | | | |
| to 60° C. & | | | | | |
| Two cycles −40° C. | | | | | |
| to 70° C. | | | | | |

Moreover, attenuation performance has been measured with respect to exemplary semi-tight buffering units in accordance with the present invention. In measuring attenuation performance, semi-tight buffering units containing either one multimode optical fiber or one single-mode optical fiber were subjected to two temperature cycles from −5° C. to 60° C. For semi-tight buffering units containing conventional multimode fibers (e.g., with a 50-micron core), attenuation at a wavelength of 1300 nanometers typically was no more than about 0.8 dB/km. Furthermore, the attenuation of semi-tight buffering units containing single-mode optical fibers was no more than about 0.5 dB/km (e.g., less than about 0.39 dB/km) at a wavelength of 1310 nanometers and no more than about 0.30 dB/km (e.g., 0.25 dB/km or less) at a wavelength of 1550 nanometers. Table 2 (below) depicts representative attenuation data from exemplary semi-tight buffering units.

TABLE 2
(Attenuation in Semi-Tight Buffering Units)

| | Ex. 6 | Ex. 7 | Ex. 8 | Ex. 9 | Ex. 10 | Ex. 11 |
|---|---|---|---|---|---|---|
| Buffer Tube | 0.9 | 0.9 | 0.9 | 0.9 | 0.9 | 0.9 |
| Outer Diameter (mm) | | | | | | |
| Buffer Tube | 0.30 | 0.30 | 0.30 | 0.30 | 0.30 | 0.30 |
| Inner Diameter (mm) | | | | | | |
| Buffering Material | ECCOH ™ 6638 | ECCOH ™ 6638 | ECCOH ™ 6638 | ECCOH ™ 6638 | ECCOH ™ 6638 | ECCOH ™ 6638 |
| Slip Agent | 075840JUMB | 075840JUMB | 075840JUMB | 075840JUMB | 075840JUMB | 075840JUMB |
| | Slipeze | Slipeze | Slipeze | Slipeze | Slipeze | Slipeze |
| Slip Agent | 3500 | 3500 | 3500 | 3500 | 3500 | 3500 |
| Concentration (ppm) | | | | | | |
| Type of | Conventional | Conventional | MaxCap ™ | MaxCap ™ | ESMF | BendBright^{XS} |
| Optical Fiber | OM1 | OM2 | OM3 | OM4 | | |
| Attenuation | ≦3.2 | ≦2.7 | ≦2.7 | ≦2.7 | N/A | N/A |
| (dB/km at 850 nm) | | | | | | |
| Two cycles −5° C. | | | | | | |
| to 60° C. | | | | | | |
| Attenuation | ≦1.0 | ≦0.8 | ≦0.8 | ≦0.8 | N/A | N/A |
| (dB/km at 1300 nm) | | | | | | |
| Two cycles −5° C. | | | | | | |
| to 60° C. | | | | | | |
| Attenuation | N/A | N/A | N/A | N/A | ≦0.39 | ≦0.39 |
| (dB/km at 1310 nm) | | | | | | |
| Two cycles −5° C. | | | | | | |
| to 60° C. | | | | | | |
| Attenuation | N/A | N/A | N/A | N/A | ≦0.25 | ≦0.25 |
| (dB/km at 1550 nm) | | | | | | |
| Two cycles −5° C. | | | | | | |
| to 60° C. | | | | | | |

One or more buffering units according to the present invention may be positioned within a fiber optic cable.

In this regard, a plurality of the present buffering units may be positioned externally adjacent to and stranded around a central strength member. This stranding can be accomplished in one direction, helically, known as “S” or “Z” stranding, or Reverse Oscillated Lay stranding, known as “S-Z” stranding. Stranding about the central strength member reduces optical fiber strain when cable strain occurs during installation and use.

Those having ordinary skill in the art will understand the benefit of minimizing fiber strain for both tensile cable strain and longitudinal compressive cable strain during installation or operating conditions.

With respect to tensile cable strain, which may occur during installation, the cable will become longer while the optical fibers can migrate closer to the cable's neutral axis to reduce, if not eliminate, the strain being translated to the optical fibers. With respect to longitudinal compressive strain, which may occur at low operating temperatures due to shrinkage of the cable components, the optical fibers will migrate farther away from the cable's neutral axis to reduce, if not eliminate, the compressive strain being translated to the optical fibers.

In a variation, two or more substantially concentric layers of buffer tubes may be positioned around a central strength member. In a further variation, multiple stranding elements (e.g., multiple buffering units stranded around a strength member) may themselves be stranded around each other or around a primary central strength member.

Alternatively, a plurality of the present buffering units may be simply placed externally adjacent to the central strength member (i.e., the buffering units are not intentionally stranded or arranged around the central strength member in a particular manner and run substantially parallel to the central strength member).

In another cabling embodiment, multiple buffering units may be stranded around themselves without the presence of a central member. These stranded buffering units may be surrounded by a protective tube. The protective tube may serve as the outer casing of the fiber optic cable or may be further surrounded by an outer sheath. The protective tube may tightly or loosely surround the stranded buffer tubes.

As will be known to those having ordinary skill in the art, additional elements may be included within a cable core. For example, copper cables or other active, transmission elements may be stranded or otherwise bundled within the cable sheath. By way of further example, passive elements may be placed outside the buffer tubes between the respective exterior walls of the buffering units and the interior wall of the cable jacket.

In this regard, yarns, nonwovens, fabrics (e.g., tapes), foams, or other materials containing water-swellable material and/or coated with water-swellable materials (e.g., including super absorbent polymers (SAPs), such as SAP powder) may be employed to provide water blocking.

As will be understood by those having ordinary skill in the art, a cable enclosing buffering units as disclosed herein may have a sheath formed from various materials in various designs. Cable sheathing may be formed from polymeric materials such as, for example, polyethylene, polypropylene, polyvinyl chloride (PVC), polyamides (e.g., nylon), polyester (e.g., PBT), fluorinated plastics (e.g., perfluorethylene propylene, polyvinyl fluoride, or polyvinylidene difluoride), and ethylene vinyl acetate. By way of example, the sheath may be formed from MEGOLON™ S540, a halogen-free thermoplastic material commercially available from Alpha Gary Corporation. The sheath materials may also contain other additives, such as nucleating agents, flame-retardants, smoke-retardants, antioxidants, UV absorbers, and/or plasticizers.

The cable sheathing may be a single jacket formed from a dielectric material (e.g., non-conducting polymers), with or without supplemental structural components that may be used to improve the protection (e.g., from rodents) and strength provided by the cable sheath. For example, one or more layers of metallic (e.g., steel) tape along with one or more dielectric jackets may form the cable sheathing. Metallic or fiberglass reinforcing rods (e.g., GRP) may also be incorporated into the sheath. In addition, aramid, fiberglass, or polyester yarns may be employed under the various sheath materials (e.g., between the cable sheath and the cable core), and/or ripcords may be positioned, for example, within the cable sheath.

Similar to buffer tubes, optical fiber cable sheaths typically have a circular cross section, but cable sheaths alternatively may have an irregular or non-circular shape (e.g., an oval, trapezoidal, or flat cross-section).

In general and as will be known to those having ordinary skill in the art, a strength member is typically in the form of a rod or braided/helically wound wires or fibers, though other configurations will be within the knowledge of those having ordinary skill in the art.

Optical fiber cables containing buffering units as disclosed may be variously deployed, including as drop cables, distribution cables, feeder cables, trunk cables, and stub cables, each of which may have varying operational requirements (e.g., temperature range, crush resistance, UV resistance, and minimum bend radius).

Such optical fiber cables may be installed within ducts, microducts, plenums, or risers. By way of example, an optical fiber cable may be installed in an existing duct or microduct by pulling or blowing (e.g., using compressed air). An exemplary cable installation method is disclosed in commonly assigned U.S. Patent Application Publication No. US2007/0263960 for a Communication Cable Assembly and Installation Method (Lock et al.), and U.S. Patent Application Publication No. US2008/0317410 for a Modified Pre-Ferrulized Communication Cable Assembly and Installation Method (Griffioen et al.), each of which is incorporated by reference in its entirety.

As noted, the present buffering units may be stranded (e.g., around a central strength member). In such configurations, an optical fiber cable's protective outer sheath may have a textured outer surface that periodically varies lengthwise along the cable in a manner that replicates the stranded shape of the underlying buffer tubes. The textured profile of the protective outer sheath can improve the blowing performance of the optical fiber cable. The textured surface reduces the contact surface between the cable and the duct or microduct and increases the friction between the blowing medium (e.g., air) and the cable. The protective outer sheath may be made of a low coefficient-of-friction material, which can facilitate blown installation. Moreover, the protective outer sheath can be provided with a lubricant to further facilitate blown installation.

In general, to achieve satisfactory long-distance blowing performance (e.g., between about 3,000 to 5,000 feet or more), the outer cable diameter of an optical fiber cable should be no more than about seventy to eighty percent of the duct's or microduct's inner diameter.

Moreover, the optical fiber cables may be directly buried in the ground or, as an aerial cable, suspended from a pole or pylon. An aerial cable may be self-supporting, or secured or lashed to a support (e.g., messenger wire or another cable). Exemplary aerial fiber optic cables include overhead ground wires (OPGW), all-dielectric self-supporting cables (ADSS), all dielectric lash cables (AD-Lash), and figure-eight cables, each of which is well understood by those having ordinary skill in the art. (Figure-eight cables and other designs can be directly buried or installed into ducts, and may optionally include a toning element, such as a metallic wire, so that they can be found with a metal detector.

To effectively employ optical fibers in a transmission system, connections are required at various points in the network. Optical fiber connections are typically made by fusion splicing, mechanical splicing, or mechanical connectors.

The mating ends of connectors can be installed to the fiber ends either in the field (e.g., at the network location) or in a factory prior to installation into the network. The ends of the connectors are mated in the field in order to connect the fibers together or connect the fibers to the passive or active components. For example, certain optical fiber cable assemblies (e.g., furcation assemblies) can separate and convey individual optical fibers from a multiple optical fiber cable to connectors in a protective manner.

The deployment of such optical fiber cables may include supplemental equipment. For instance, an amplifier may be included to improve optical signals. Dispersion compensating modules may be installed to reduce the effects of chromatic dispersion and polarization mode dispersion. Splice boxes, pedestals, and distribution frames, which may be protected by an enclosure, may likewise be included. Additional elements include, for example, remote terminal switches, optical network units, optical splitters, and central office switches.

A cable containing the present buffering units may be deployed for use in a communication system (e.g., networking or telecommunications). A communication system may include fiber optic cable architecture such as fiber-to-the-node (FTTN), fiber-to-the-telecommunications enclosure (FTTE), fiber-to-the-curb (FITC), fiber-to-the-building (FTTB), and fiber-to-the-home (FTTH), as well as long-haul or metro architecture. Moreover, an optical module or a storage box that includes a housing may receive a wound portion of an optical fiber. By way of example, the optical fiber may be wound with a bending radius of less than about 15 millimeters (e.g., 10 millimeters or less, such as about 5 millimeters) in the optical module or the storage box.

To supplement the present disclosure, this application incorporates entirely by reference the following commonly assigned patents, patent application publications, and patent applications: U.S. Pat. No. 4,838,643 for a Single Mode Bend Insensitive Fiber for Use in Fiber Optic Guidance Applications (Hodges et al.); U.S. Pat. No. 7,623,747 for a Single Mode Optical Fiber (de Montmorillon et al.); U.S. Pat. No. 7,587,111 for a Single-Mode Optical Fiber (de Montmorillon et al.); U.S. Pat. No. 7,356,234 for a Chromatic Dispersion Compensating Fiber (de Montmorillon et al.); U.S. Pat. No. 7,483,613 for a Chromatic Dispersion Compensating Fiber (Bigot-Astruc et al.); U.S. Pat. No. 7,555,186 for an Optical Fiber (Flammer et al.); U.S. Patent Application Publication No. US2009/0252469 A1 for a Dispersion-Shifted Optical Fiber (Sillard et al.); U.S. patent application Ser. No. 12/098,804 for a Transmission Optical Fiber Having Large Effective Area (Sillard et al.), filed Apr. 7, 2008; International Patent Application Publication No. WO 2009/062131 A1 for a Microbend-Resistant Optical Fiber, (Overton); U.S. Patent Application Publication No. US2009/0175583 A1 for a Microbend-Resistant Optical Fiber, (Overton); U.S. Patent Application Publication No. US2009/0279835 A1 for a Single-Mode Optical Fiber Having Reduced Bending Losses, filed May 6, 2009, (de Montmorillon et al.); U.S. Patent Application Publication No. US2009/0279836 A1 for a Bend-Insensitive Single-Mode Optical Fiber, filed May 6, 2009, (de Montmorillon et al.); U.S. Patent Application Publication No. US2010/0021170 A1 for a Wavelength Multiplexed Optical System with Multimode Optical Fibers, filed Jun. 23, 2009, (Lumineau et al.); U.S. Patent Application Publication No. US2010/0028020 A1 for a Multimode Optical Fibers, filed Jul. 7, 2009, (Gholami et al.); U.S. Patent Application Publication No. US2010/0119202 A1 for a Reduced-Diameter Optical Fiber, filed Nov. 6, 2009, (Overton); U.S. Patent Application Publication No. US2010/0142969 A1 for a Multimode Optical System, filed Nov. 6, 2009, (Gholami et al.); U.S. Patent Application Publication No. US2010/0118388 A1 for an Amplifying Optical Fiber and Method of Manufacturing, filed Nov. 12, 2009, (Pastouret et al.); U.S. Patent Application Publication No. US2010/0135627 A1 for an Amplifying Optical Fiber and Production Method, filed Dec. 2, 2009, (Pastouret et al.); U.S. patent application Ser. No. 12/633,229 for an Ionizing Radiation-Resistant Optical Fiber Amplifier, filed Dec. 8, 2009, (Regnier et al.); U.S. Patent Application Publication No. US2010/0150505 A1 for a Buffered Optical Fiber, filed Dec. 11, 2009, (Testu et al.); U.S. patent application Ser. No. 12/683,775 for a Method of Classifying a Graded-Index Multimode Optical Fiber, filed Jan. 7, 2010, (Gholami et al.); U.S. patent application Ser. No. 12/692,161 for a Single-Mode Optical Fiber, filed Jan. 22, 2010, (Richard et al.); U.S. patent application Ser. No. 12/694,533 for a Single-Mode Optical Fiber Having an Enlarged Effective Area, filed Jan. 27, 2010, (Sillard et al.); U.S. patent application Ser. No. 12/694,559 for a Single-Mode Optical Fiber, filed Jan. 27, 2010, (Sillard et al.); U.S. patent application Ser. No. 12/708,810 for a Optical Fiber Amplifier Having Nanostructures, filed Feb. 19, 2010, (Burov et al.); and U.S. patent application Ser. No. 12/765,182 for a Multimode Fiber, filed Apr. 22, 2010, (Molin et al.).

To supplement the present disclosure, this application further incorporates entirely by reference the following commonly assigned patents, patent application publications, and patent applications: U.S. Pat. No. 5,574,816 for Polypropylene-Polyethylene Copolymer Buffer Tubes for Optical Fiber Cables and Method for Making the Same; U.S. Pat. No. 5,717,805 for Stress Concentrations in an Optical Fiber Ribbon to Facilitate Separation of Ribbon Matrix Material; U.S. Pat. No. 5,761,362 for Polypropylene-Polyethylene Copolymer Buffer Tubes for Optical Fiber Cables and Method for Making the Same; U.S. Pat. No. 5,911,023 for Polyolefin Materials Suitable for Optical Fiber Cable Components; U.S. Pat. No. 5,982,968 for Stress Concentrations in an Optical Fiber Ribbon to Facilitate Separation of Ribbon Matrix Material; U.S. Pat. No. 6,035,087 for an Optical Unit for Fiber Optic Cables; U.S. Pat. No. 6,066,397 for Polypropylene Filler Rods for Optical Fiber Communications Cables; U.S. Pat. No. 6,175,677 for an Optical Fiber Multi-Ribbon and Method for Making the Same; U.S. Pat. No. 6,085,009 for Water Blocking Gels Compatible with Polyolefin Optical Fiber Cable Buffer Tubes and Cables Made Therewith; U.S. Pat. No. 6,215,931 for Flexible Thermoplastic Polyolefin Elastomers for Buffering Transmission Elements in a Telecommunications Cable; U.S. Pat. No. 6,134,363 for a Method for Accessing Optical Fibers in the Midspan Region of an Optical Fiber Cable; U.S. Pat. No. 6,381,390 for a Color-Coded Optical Fiber Ribbon and Die for Making the Same; U.S. Pat. No. 6,181,857 for a Method for Accessing Optical Fibers Contained in a Sheath; U.S. Pat. No. 6,314,224 for a Thick-Walled Cable Jacket with Non-Circular Cavity Cross Section; U.S. Pat. No. 6,334,016 for an Optical Fiber Ribbon Matrix Material Having Optimal Handling Characteristics; U.S. Pat. No. 6,321,012 for an Optical Fiber Having Water Swellable Material for Identifying Grouping of Fiber Groups; U.S. Pat. No. 6,321,014 for a Method for Manufacturing Optical Fiber Ribbon; U.S. Pat. No. 6,210,802 for Polypropylene Filler Rods for Optical Fiber Communications Cables; U.S. Pat. No. 6,493,491 for an Optical Drop Cable for Aerial Installation; U.S. Pat. No. 7,346,244 for a Coated Central Strength Member for Fiber Optic Cables with Reduced Shrinkage; U.S. Pat. No. 6,658,184 for a Protective Skin for Optical Fibers; U.S. Pat. No. 6,603,908 for a Buffer Tube that Results in Easy Access to and Low Attenuation of Fibers Disposed Within Buffer Tube; U.S. Pat. No. 7,045,010 for an Applicator for High-Speed Gel Buffering of Flextube Optical Fiber Bundles; U.S. Pat. No. 6,749,446 for an Optical Fiber Cable with Cushion Members Protecting Optical Fiber Ribbon Stack; U.S. Pat. No. 6,922,515 for a Method and Apparatus to Reduce Variation of Excess Fiber Length in Buffer Tubes of Fiber Optic Cables; U.S. Pat. No. 6,618,538 for a Method and Apparatus to Reduce Variation of Excess Fiber Length in Buffer Tubes of Fiber Optic Cables; U.S. Pat. No. 7,322,122 for a Method and Apparatus for Curing a Fiber Having at Least Two Fiber Coating Curing Stages; U.S. Pat. No. 6,912,347 for an Optimized Fiber Optic Cable Suitable for Microduct Blown Installation; U.S. Pat. No. 6,941,049 for a Fiber Optic Cable Having No Rigid Strength Members and a Reduced Coefficient of Thermal Expansion; U.S. Pat. No. 7,162,128 for Use of Buffer Tube Coupling Coil to Prevent Fiber Retraction; U.S. Pat. No. 7,515,795 for a Water-Swellable Tape, Adhesive-Backed for Coupling When Used Inside a Buffer Tube (Overton et al.); U.S. Patent Application Publication No. 2008/0292262 for a Grease-Free Buffer Optical Fiber Buffer Tube Construction Utilizing a Water-Swellable, Texturized Yarn (Overton et al.); European Patent Application Publication No. 1,921,478 A1, for a Telecommunication Optical Fiber Cable (Tatat et al.); U.S. Pat. No. 7,702,204 for a Method for Manufacturing an Optical Fiber Preform (Gonnet et al.); U.S. Pat. No. 7,570,852 for an Optical Fiber Cable Suited for Blown Installation or Pushing Installation in Microducts of Small Diameter (Nothofer et al.); U.S. Pat. No. 7,526,177 for a Fluorine-Doped Optical Fiber (Matthijsse et al.); U.S. Pat. No. 7,646,954 for an Optical Fiber Telecommunications Cable (Tatat); U.S. Pat. No. 7,599,589 for a Gel-Free Buffer Tube with Adhesively Coupled Optical Element (Overton et al.); U.S. Pat. No. 7,567,739 for a Fiber Optic Cable Having a Water-Swellable Element (Overton); U.S. Patent Application Publication No. US2009/0041414 A1 for a Method for Accessing Optical Fibers within a Telecommunication Cable (Lavenne et al.); U.S. Pat. No. 7,639,915 for an Optical Fiber Cable Having a Deformable Coupling Element (Parris et al.); U.S. Pat. No. 7,646,952 for an Optical Fiber Cable Having Raised Coupling Supports (Parris); U.S. Patent Application Publication No. US2009/0003785 A1 for a Coupling Composition for Optical Fiber Cables (Parris et al.); U.S. Patent Application Publication No. US2009/0214167 A1 for a Buffer Tube with Hollow Channels, (Lookadoo et al.); U.S. patent application Ser. No. 12/466,965 for an Optical Fiber Telecommunication Cable, filed May 15, 2009, (Tatat); U.S. patent application Ser. No. 12/506,533 for a Buffer Tube with Adhesively Coupled Optical Fibers and/or Water-Swellable Element, filed Jul. 21, 2009, (Overton et al.); U.S. Patent Application Publication No. US2010/0092135 A1 for an Optical Fiber Cable Assembly, filed Sep. 10, 2009, (Barker et al.); U.S. patent application Ser. No. 12/557,086 for a High-Fiber-Density Optical Fiber Cable, filed Sep. 10, 2009, (Louie et al.); U.S. Patent Application Publication No. US2010/0067855 A1 for a Buffer Tubes for Mid-Span Storage, filed Sep. 11, 2009, (Barker); U.S. Patent Application Publication No. US2010/0135623 A1 for Single-Fiber Drop Cables for MDU Deployments, filed Nov. 9, 2009, (Overton); U.S. Patent Application Publication No. US2010/0092140 A1 for an Optical-Fiber Loose Tube Cables, filed Nov. 9, 2009, (Overton); U.S. Patent Application Publication No. US2010/0135624 A1 for a Reduced-Size Flat Drop Cable, filed Nov. 9, 2009, (Overton et al.); U.S. Patent Application Publication No. US2010/0092138 A1 for ADSS Cables with High-Performance Optical Fiber, filed Nov. 9, 2009, (Overton); U.S. Patent Application Publication No. US2010/0135625 A1 for Reduced-Diameter Ribbon Cables with High-Performance Optical Fiber, filed Nov. 10, 2009, (Overton); U.S. Patent Application Publication No. US2010/0092139 A1 for a Reduced-Diameter, Easy-Access Loose Tube Cable, filed Nov. 10, 2009, (Overton); U.S. Patent Application Publication No. US2010/0154479 A1 for a Method and Device for Manufacturing an Optical Preform, filed Dec. 19, 2009, (Milicevic et al.); U.S. patent application Ser. No. 12/648,794 for a Perforated Water-Blocking Element, filed Dec. 29, 2009, (Parris); U.S. patent application Ser. No. 12/649,758 for a UVLED Apparatus for Curing Glass-Fiber Coatings, filed Dec. 30, 2009, (Hartsuiker et al.); U.S. patent application Ser. No. 12/700,293 for a Central-Tube Cable with High-Conductivity Conductors Encapsulated with High-Dielectric-Strength Insulation, filed Feb. 4, 2010, (Ryan et al.); U.S. patent application Ser. No. 12/710,584 for a Cable Having Lubricated, Extractable Elements, filed Feb. 23, 2010, (Tatat et al.); and U.S. patent application Ser. No. 12/794,229 for a Large Bandwidth Multimode Optical Fiber Having a Reduced Cladding Effect, filed Jun. 4, 2010, (Molin et al.).

This application further incorporates by reference product specifications for the following Draka multimode optical fibers: (i) Graded-Index Multimode Optical Fiber (50/125 μm), (ii) MaxCap™-OM2⁺ Optical Fiber, (iii) MaxCap™-OM3 Optical Fiber, (iv) MaxCap™-OM4 Optical Fiber, and (v) MaxCap™-BB-OMx Optical Fiber. This technical information is provided as Appendices 1-5, respectively, in commonly assigned U.S. Patent Application No. 61/328,837 for a Data-Center Cable, filed Apr. 28, 2010 (Louie et al.), which is incorporated by reference in its entirety.

Moreover, this application incorporates by reference product specifications for the following Draka single-mode optical fibers: (i) Enhanced Single-Mode Optical Fiber (ESMF), (ii) BendBright™ Single Mode Optical Fiber, (iii) BendBright^{XS}™ Single-Mode Optical Fiber, and (iv) DrakaElite™ BendBright-Elite Fiber. This technical information is provided as Appendices 10-12, respectively, in commonly assigned U.S. Patent Application No. 61/112,595 for a Microbend-Resistant Optical Fiber, filed Nov. 7, 2008, (Overton) and as Appendices I-IV, respectively, in commonly assigned U.S. Patent Application No. 61/248,319 for a Reduced-Diameter Optical Fiber, filed Oct. 2, 2009, (Overton), each of which is incorporated by reference in its entirety.

In the specification and/or figures, typical embodiments of the invention have been disclosed. The present invention is not limited to such exemplary embodiments. The figures are schematic representations and so are not necessarily drawn to scale. Unless otherwise noted, specific terms have been used in a generic and descriptive sense and not for purposes of limitation.

1. A tight-buffered optical fiber unit, comprising:
an optical fiber comprising a glass fiber surrounded by a optical-fiber coating including one or more coating layers; and
a polymeric buffering layer tightly surrounding the optical fiber to define a fiber-buffer interface, the polymeric buffering layer including an aliphatic amide slip agent in an amount sufficient for at least some of the aliphatic amide slip agent to migrate to the fiber-buffer interface and thereby promote easy stripping of the polymeric buffering layer;
wherein at least about 15 centimeters of the polymeric buffering layer can be removed from the optical fiber in a single operation using a strip force of less than about 10 N.

2. An optical fiber unit according to claim 1, wherein the optical-fiber coating includes a primary coating layer surrounding the glass fiber and a secondary coating layer surrounding the primary coating layer.

3. An optical fiber unit according to claim 2, wherein the optical-fiber coating includes an ink layer surrounding the secondary coating layer.

4. An optical fiber unit according to claim 1, wherein the outer diameter of the optical fiber and the inner diameter of the polymeric buffering layer are essentially the same.

5. An optical fiber unit according to claim 1, wherein the polymeric buffering layer has a Shore A hardness of at least about 90.

6. An optical fiber unit according to claim 1, wherein:
the polymeric buffering layer predominately comprises a polyolefin; and
the aliphatic amide slip agent possesses low solubility within the polyolefin to facilitate the migration of the aliphatic amide slip agent to the fiber-buffer interface.

7. An optical fiber unit according to claim 1, wherein the aliphatic amide slip agent is incorporated into the polymeric buffering layer in an amount less than about 3000 ppm.

8. An optical fiber unit according to claim 1, wherein the aliphatic amide slip agent is incorporated into the polymeric buffering layer in an amount between about 750 ppm and 1250 ppm.

9. An optical fiber unit according to claim 1, wherein at least about 20 centimeters of the polymeric buffering layer can be removed from the optical fiber in a single operation using a strip force of less than about 5 N.

10. An optical fiber unit according to claim 1, wherein at least about 30 centimeters of the polymeric buffering layer can be removed from the optical fiber in a single operation using a strip force of less than about 10 N.

11. An optical fiber unit according to claim 1, wherein:
the optical fiber is a multimode optical fiber complying with the ITU-T G.651.1 recommendation; and
the optical fiber unit has, at a wavelength of 1300 nanometers, attenuation less than about 1 dB/km as measured at −5° C. after performing two temperature cycles from −5° C. to 60° C.

12. An optical fiber unit according to claim 11, wherein:
the multimode optical fiber has macrobending losses greater than 0.1 dB at a wavelength of 850 nanometers for a winding of two turns around a spool with a bending radius of 15 millimeters; and
the multimode optical fiber has macrobending losses greater than 0.3 dB at a wavelength of 1300 nanometers for a winding of two turns around a spool with a bending radius of 15 millimeters.

13. An optical fiber unit according to claim 1, wherein:
the optical fiber is a multimode optical fiber complying with the ITU-T G.651.1 recommendation; and
the optical fiber unit has, at a wavelength of 1300 nanometers, attenuation less than about 0.6 dB/km as measured at −5° C. after performing two temperature cycles from −5° C. to 60° C.

14. An optical fiber unit according to claim 13, wherein:
the multimode optical fiber has macrobending losses greater than 0.1 dB at a wavelength of 850 nanometers for a winding of two turns around a spool with a bending radius of 15 millimeters; and
the multimode optical fiber has macrobending losses greater than 0.3 dB at a wavelength of 1300 nanometers for a winding of two turns around a spool with a bending radius of 15 millimeters.

15. An optical fiber unit according to claim 1, wherein:
the optical fiber is a single-mode optical fiber; and
as measured at −5° C. after performing two temperature cycles from −40° C. to 70° C., the optical fiber unit has attenuation (i) less than about 0.5 dB/km at a wavelength of 1310 nanometers and (ii) less than about 0.3 dB/km at a wavelength of 1550 nanometers.

16. A method for manufacturing an optical fiber unit according to claim 1, comprising:
incorporating an aliphatic amide slip agent into a polymeric composition to form a polymeric buffering compound;
extruding the polymeric buffering compound continuously around the optical fiber to form the optical fiber unit.

17. A method according to claim 16, wherein the step of incorporating an aliphatic amide slip agent into a polymeric composition comprises incorporating into a polyolefin an aliphatic amide slip agent that has sufficiently low solubility within the polyolefin to promote the migration of the aliphatic amide slip agent to the fiber-buffer interface during and/or after the extrusion step.

18. A semi-tight-buffered optical fiber unit, comprising:
an optical fiber comprising a glass fiber surrounded by a optical-fiber coating including one or more coating layers; and
a polymeric buffering layer surrounding the optical fiber to define an annular gap therebetween, the polymeric buffering layer including an aliphatic amide slip agent in an amount sufficient for at least some of the aliphatic amide slip agent to migrate to the annular gap and thereby promote easy stripping of the polymeric buffering layer;
wherein at least about 25 centimeters of the polymeric buffering layer can be removed from the optical fiber in a single operation using a strip force of less than about 10 N.

19. An optical fiber unit according to claim 18, wherein the optical-fiber coating includes a primary coating layer surrounding the glass fiber and a secondary coating layer surrounding the primary coating layer.

20. An optical fiber unit according to claim 19, wherein the optical-fiber coating includes an ink layer surrounding the secondary coating layer.

21. An optical fiber unit according to claim 18, wherein the inner diameter of the polymeric buffering layer is no more than about 30 microns greater than the outer diameter of the optical fiber.

22. An optical fiber unit according to claim 18, wherein the polymeric buffering layer has a Shore A hardness of at least about 90.

23. An optical fiber unit according to claim 18, wherein the polymeric buffering layer predominately comprises a polyolefin.

24. An optical fiber unit according to claim 18, wherein the aliphatic amide slip agent is incorporated into the polymeric buffering layer in an amount between about 200 ppm and 2000 ppm.

25. An optical fiber unit according to claim 18, wherein at least about 50 centimeters of the polymeric buffering layer can be removed from the optical fiber in a single operation using a strip force of less than about 5 N.

26. An optical fiber unit according to claim 18, wherein at least about 100 centimeters of the polymeric buffering layer can be removed from the optical fiber in a single operation using a strip force of less than about 10 N.

27. An optical fiber unit according to claim 18, wherein:
the optical fiber is a multimode optical fiber complying with the ITU-T G.651.1 recommendation; and
the optical fiber unit has, at a wavelength of 1300 nanometers, attenuation less than about 1 dB/km as measured at −5° C. after performing two temperature cycles from −5° C. to 60° C.

28. An optical fiber unit according to claim 27, wherein:
the multimode optical fiber has macrobending losses greater than 0.1 dB at a wavelength of 850 nanometers for a winding of two turns around a spool with a bending radius of 15 millimeters; and
the multimode optical fiber has macrobending losses greater than 0.3 dB at a wavelength of 1300 nanometers for a winding of two turns around a spool with a bending radius of 15 millimeters.

29. An optical fiber unit according to claim 18, wherein:
the optical fiber is a multimode optical fiber complying with the ITU-T G.651.1 recommendation; and
the optical fiber unit has, at a wavelength of 1300 nanometers, attenuation less than about 0.8 dB/km as measured at −5° C. after performing two temperature cycles from −5° C. to 60° C.

30. An optical fiber unit according to claim 29, wherein:
the multimode optical fiber has macrobending losses greater than 0.1 dB at a wavelength of 850 nanometers for a winding of two turns around a spool with a bending radius of 15 millimeters; and
the multimode optical fiber has macrobending losses greater than 0.3 dB at a wavelength of 1300 nanometers for a winding of two turns around a spool with a bending radius of 15 millimeters.

31. An optical fiber unit according to claim 18, wherein:
the optical fiber is a single-mode optical fiber; and
as measured at −5° C. after performing two temperature cycles from −5° C. to 60° C., the optical fiber unit has attenuation (i) less than about 0.5 dB/km at a wavelength of 1310 nanometers and (ii) less than about 0.3 dB/km at a wavelength of 1550 nanometers.

32. An optical fiber unit according to claim 31, wherein the single-mode optical fiber (i) complies with the ITU-T G.652.D recommendation but (ii) complies with neither the ITU-T G.657.A recommendation nor the ITU-T G.657.B recommendation.
